(19) United States
(12) Patent Application Publication
(10) Pub. No.: US 2016/0006004 A1
(43) Pub. Date: Jan. 7, 2016

(54) GASKET FOR SECONDARY BATTERY

(71) Applicant: YODOGAWA HU-TECH CO., LTD., Osaka-shi, Osaka (JP)

(72) Inventors: Katsumi OGAWA, Osaka (JP); Isao AWAI, Osaka (JP); Hiroyuki TORII, Shiga (JP); Tomohiro ONO, Osaka (JP); Shin-ichi SAKASHITA, Shiga (JP); Mikimasa KOKADO, Shiga (JP)

(21) Appl. No.: 14/768,522

(22) PCT Filed: Feb. 16, 2014
(86) PCT No.: PCT/JP2014/053567

§ 371 Date: Aug. 18, 2015

(30) Foreign Application Priority Data
Feb. 20, 2013 (JP) 2013-030501

(51) Int. Cl. H01M 2/08; H01M 2/02; H01M 10/0525

(52) U.S. Cl. CPC H01M 2/08; H01M 10/0525; H01M 2/0237; H01M 2220/20

(57) ABSTRACT

An object is to provide a gasket for a secondary battery having excellent compressive restoration characteristics. A gasket for a secondary battery (particularly for a lithium secondary battery) is a gasket used as an insulation seal of a secondary battery, and is a hot-press and cold-press molded product (particularly, a product which is hot-pressed into a gasket shape under a temperature condition lower than a melting point of a tetrafluoroethylene-perfluoroalkyl vinyl ether copolymer (PFA) that is used by 0° C. to 80° C. and is thereafter cooled under pressure) obtained by hot-pressing a skived sheet obtained by skiving a block-shaped molded body (particularly, a columnar or cylindrical molded body obtained by injecting a PFA raw material into a heated mold to be pressurized and cooling the material under pressure) made of a PFA to be deformed into a gasket shape and thereafter performing cold-pressing on the resultant to fix a shape thereof.

### TECHNICAL FIELD

The present invention relates to a gasket for a secondary battery (particularly, a lithium-ion secondary battery) having excellent compressive restoration characteristics.

### BACKGROUND ART

### Gasket for Secondary Battery

A gasket (a synonym for a packing) as a seal material is essential to a secondary battery represented by a lithium-ion secondary battery.

The shape of a representative gasket is a circular shape, an oval shape, a rounded rectangle shape, or the like in a plan view and has a through-hole in the center portion thereof.

The material of the gasket for the secondary battery is preferably a fluorine-based resin in terms of performance such as heat resistance, heat shock resistance, or stress cracking resistance, and among fluorine-based resins, a tetrafluoroethylene-perfluoroalkyl vinyl ether copolymer (PFA) is optimal.

There are many suggestions for the gasket for the secondary battery made of the fluorine-based resin (particularly, PFA), and as patent documents related to the invention, Patent Document 1 and Patent Document 2, which are described below, are considered.

### Patent Document 1

In claim 1 of JP 11-16548 A (JP 3616728 B1) applied by the applicant, “a method of manufacturing a packing for a secondary battery, the method including heating a material molded product 1 made of a fluorine-based resin to a softening temperature thereof or higher so as to be softened, applying a pressure to the material molded product 1 using a mold so as to be deformed into a softened three-dimensional molded product 2, and thereafter cooling the softened three-dimensional molded product 2 to the softening temperature or lower so as to be formed into a target molded product 3.” is described.

In paragraphs 0001 and 0031 thereof, “packing (gasket)” is described, and it is noted just in case that the packing and the gasket are synonyms.

In claim 3 thereof, it is described that “the material molded product 1 is an extrusion-molded product of the fluorine-based resin”. In paragraph 0018 thereof, it is described that “the material molded product is particularly preferably the extrusion-molded product of the fluorine-based resin”.

In paragraph 0037 according to Example 1 thereof, a material molded product 1 having a flat circular shape is produced by punching a PFA sheet having a thickness of 0.6 mm, which is made by extrusion molding of a PFA.

In paragraph 0044 according to Example 2 thereof and paragraph 0047 according to Example 3 thereof, a material molded product 1 having a flat rectangular shape is produced by punching a PFA sheet, which is made by extrusion molding of a PFA.

In paragraph 0055 according to Example 6 thereof, work is performed on a long material molded product 1 formed of a PFA sheet having a thickness of 0.5 mm, which is made by extrusion molding of a PFA.

In addition, in Examples 4 and 5, a material molded product 1 is obtained from a FEP sheet, which is made by extrusion molding of a tetrafluoroethylene-hexafluoropropylene copolymer (FEP) instead of PFA.

In paragraph 0011 thereof, there is a description that “particularly preferably, a method of manufacturing a packing for a secondary battery of the invention includes a process A of supplying of a material molded product 1 which has substantially the same volume as that of a mold cavity after compression and is made of a fluorine-based resin, into a mold, a process B of heating the material molded product 1 to a softening temperature thereof or higher in the mold or before being supplied to the mold so as to be softened and applying a pressure to the mold so as to deform the material molded product 1 to a softened three-dimensional molded product 2 having a three-dimensional shape corresponding to the mold cavity, and a process C of cooling the softened three-dimensional molded product 2 to the softening temperature or lower while maintaining the pressurized state so as to be formed into a target molded product 3 and releasing the target molded product 3 from the mold.”

In paragraph 0017 thereof, there is a description that “as the fluorine-based resin, FEP, PTFE, fluorine-based rubber, or the like can be used, and a tetrafluoroethylene-perfluoroalkyl vinyl ether copolymer (PFA) is particularly important”.

In paragraph 0022 thereof, there is a description that the material molded product is heated to a softening temperature or higher so as to be softened and is deformed into a three-dimensional shape corresponding to the mold cavity by applying a pressure to the mold.

In paragraph 0036 thereof, there is a description that regarding the application, “the packing is useful as a packing (gasket) made of a fluorine-based resin used for an insulation seal of a secondary battery, and particularly, a lithium secondary battery.”

### Patent Document 2

In claim 1 of JP 2001-71376 A (Patent Document 2) applied by the applicant, “a method of manufacturing a packing for a secondary battery, the method including cold-pressing a sheet made of a fluorine-based resin by using a mold so as to be plastically deformed into a three-dimensional shape, and punching the sheet into a target size simultaneously with the plastic deformation or before or after the plastic deformation.” is described.

In paragraphs 0001 and 0027 thereof, “packing (gasket)” is described, and it is noted that the packing and the gasket are synonyms.

Here, “cold working” means, as described in paragraph 0023 thereof, performing pressing typically in a range of about 5° C. to 50° C., particularly 10° C. to 40° C., and particularly 15° C. to 30° C., for example, at a pressure of about 50 kg/cm² to 500 kg/cm².

In paragraph 0017 thereof, there is a description that “The sheet made of the fluorine-based resin may be obtained by an arbitrary molding method, and for example, in a case of PFA or FEP, a method of “skiving” a columnar body obtained by a direct pressure molding method, that is, a method of obtaining sheets by a method of slicing the columnar body so as to peel away the outer peripheral surface of the columnar body is particularly appropriately employed in terms of thickness precision and productivity. In addition, a method of obtaining sheets through extrusion molding, a method of obtaining a packing-like sheet sliced from a round bar, and the like are possible.”

In paragraph 0034 according to Example 1, it is described that “as a sheet S made of the fluorine-based resin, a PFA sheet (a slightly opalescent transparent sheet) having a thickness d of 0.5 mm, which was obtained by skiving a columnar body obtained by performing direct pressure molding on an PFA having a melt flow index of 2 g/10 min at 320° C. was prepared.”

In addition, in paragraph 0038 according to Example 1, it is described that “Stepped portions formed by plastic deformation of this product packing remained as a streaky pattern obtained when a film was produced through skiving when the stepped portions were observed by a microscope as illustrated in FIG. 3 and it is expressed that plastic deformation by cold-pressing was carried out. In addition, even the stepped portions had good strength at the same level as that of a hot-pressed product.”

In paragraph 0040 according to Example 2 thereof, it is described that “as the sheet (S) made of the fluorine-based resin, a PFA sheet having a thickness d of 0.4 mm, which was obtained by skiving a columnar body obtained by performing direct pressure molding on an PFA having a melt flow index of 2 g/10 min at 320° C. was prepared, and a product packing was manufactured under the same conditions as those of Example 1.”

In paragraph 0038 according to Example 1, paragraph 0041 according to Example 2, and paragraph 0044 according to the effect of the invention, the advantages of the cold-pressed product of the invention of Patent Document 2 are described compared to a “hot-pressed product” or “a method using hot-pressing”.

However, as mentioned in paragraph 0005 and paragraphs 0009 to 0010 of Patent Document 2, the “hot-pressed product” is associated with “a method including a process of heating a material molded product (a sheet formed by extrusion molding) to the softening temperature thereof or higher so as to be softened” described in JP 11-16548 A (Patent Document 1) which is a method according to the related art prior to Patent Document 2, and there is no hot-pressed product from a skived sheet.

In addition, in the description of “Example” of Patent Document 2, order in which a product packing is obtained from a PFA sheet obtained by skiving a columnar body subjected to direct pressure molding is described in detail. However, regarding a comparative packing compared to the packing, a “hot-pressed product” is simply mentioned, and there is no description of conditions under which the packing is produced.

This means that the “hot-pressed product” mentioned in Example of Patent Document 2 for comparison is not a hot-press molded product from a skived sheet. As described later, the inventors of Patent Document 2 possessed a product packing (gasket) as a molded product obtained by hot-pressing an extrusion-molded sheet in Patent Document 1 and thus used the packing for comparison.

That is, since Patent Document 1 and Patent Document 2 are applied by the same applicant (the applicant of this case is changed in name from the applicant of Patent Documents 1 and 2, and the applicants have the same identification number), the head inventor of Patent Document 1 and the head inventor of Patent Document 2 are the same. Therefore, there was a situation in which the product gasket according to Patent Document 1 was possessed in a procedure for finding the invention of Patent Document 2 and thus used as a comparative example in the application of Patent Document 2.

Furthermore, when it is assumed that the “hot-pressed product” mentioned in Example of Patent Document 2 for comparison is a hot-press molded product from a skived sheet, the hot-pressed product is extremely similar to that of the invention and thus will exhibit excellent compressive restoration characteristics, and thus the product from which an excellent packing (gasket) is obtained will not be described in “Comparative Example” of Patent Document 2. From this, it also can be seen that the “hot-pressed product” mentioned in Example of Patent Document 2 for comparison is a “hot-press molded product from an extrusion-molded sheet” in Patent Document 1.

The application of Patent Document 2 is assumed to be withdrawn by no request for examination. The reason is that there was a situation that although the invention of Patent Document 2 was preferable in terms of thermal energy because a gasket was produced by cold-pressing a sheet, it was thereafter determined that the invention of Patent Document 2 was disadvantageous compared to the invention of Patent Document 1 in terms of compressive restoration characteristics which are important, and thus request for examination regarding the invention of Patent Document 2 was not made.

### CITATION LIST

### Patent Document

Patent Document 1: JP 11-16548A

Patent Document 2: JP 2001-71376 A

### DISCLOSURE OF THE INVENTION

### Problem to Be Solved by the Invention

### Regarding Patent Document 1

The invention of Patent Document 1 described above is characterized in that a material molded product 1 made of a fluorine-based resin is heated to a softening temperature thereof or higher so as to be softened, a pressure is applied to the material molded product 1 using a mold so as to be deformed into a softened three-dimensional molded product 2, and thereafter the softened three-dimensional molded product 2 is cooled to the softening temperature or lower so as to be formed into a target molded product 3.

Here, a representative example of the fluorine-based resin is a “PFA”, and a “sheet-like extrusion-molded product obtained by extrusion molding” is described in detail as the material molded product 1.

When the case of the PFA is exemplified, extrusion molding is performed by melting and kneading a PFA at a temperature higher than the melting point of the PFA and discharging the PFA from a die.

The softened three-dimensional molded product 2 (gasket) is produced by pressurizing and heating (that is, “hot-pressing”) the material molded product 1 having an appropriate size in a mold at a temperature of 50° C. to 0° C. lower than the melting point (about 310° C.) of the PFA (for example, at a temperature of about 260° C. to 300° C.), for example, at a pressure of 50 kg/cm² to 300 kg/cm² and thereafter cooling the material molded product 1 to the softening temperature or lower.

The gasket produced as described above is excellent in stress cracking resistance during use as a gasket for a secondary battery and is gaining public favor in the market.

However, highly upgraded performance is required of the gasket for a secondary battery (particularly, a gasket for a lithium-ion secondary battery) by the market, and the introduction of a durable product which does not cause problems such as liquid leakage over a long period of time is desirable.

### Regarding Patent Document 2

According to the examinations by the inventors, it can be said that the gasket (packing) of Patent Document 2 obtained by a different manufacturing method from the manufacturing method of Patent Document 1 is equal to the gasket obtained by the manufacturing method of Patent Document 1 in terms of the mechanical strength of the gasket itself.

In addition, there are advantages superior to the manufacturing method of Patent Document 1 in terms of thermal energy and working environments needed to manufacture the gasket.

However, according to the examinations by the inventors, it was determined that the compressive restoration characteristics obtained when the gasket is actually assembled to the secondary battery were significantly inferior to the compressive restoration characteristics of the gasket of Patent Document 1 as well as the compressive restoration characteristics of the gasket of the invention (refer to Comparative Example 2, which will be described later).

### Purpose of the Invention

The inventors thought that the limitation on the durability of the gasket produced by the manufacturing method of Patent Document 1 or Patent Document 2 was caused by liquid leakage due to “fatigue” of the gasket caused by a long-term usage, and intensively repeated examinations from the viewpoint of enhancing the compressive restoration characteristics of the gasket.

In addition, various countermeasures including a method of selecting a material having sufficient elasticity as a gasket material, a method of mixing an additive having elasticity such as fluorine-based rubber particles with a gasket material, and a method of allowing a gasket to have a two-layer structure of PFA sheets and interposing a layer having elasticity between the layers have been attempted.

However, the methods came to a deadlock because desired elasticity could not be obtained or other problems such as interlayer separation occurred even though elasticity was obtained.

An object of the invention is to provide a gasket made of a PFA capable of reliably enhancing compressive restoration characteristics (that is, “compressive repulsion restoration characteristics”) under such circumstances.

### Means for Solving Problem

A gasket for a secondary battery of the invention is a gasket used as an insulation seal of a secondary battery, in which a material of the gasket is made of a tetrafluoroethylene-perfluoroalkyl vinyl ether copolymer (PFA), and the gasket is a hot-press and cold-press molded product obtained by hot-pressing a skived sheet obtained by skiving a block-shaped molded body made of the PFA so as to be deformed into a gasket shape and thereafter performing cold-pressing on the resultant to fix a shape thereof.

Here, it is particularly preferable that the block-shaped molded body be a columnar or cylindrical molded body obtained by injecting a PFA raw material into a heated mold so as to be pressurized and cooling the material under pressure, and the hot-press and cold-press molded product be a product which is hot-pressed into the gasket shape under a temperature condition lower than a melting point of the PFA that is used by 0° C. to 80° C. and is thereafter cooled under pressure.

In addition, it is preferable that the block-shaped molded body be obtained by molding the PFA raw material in a transfer molding method.

In the gasket G for a secondary battery of the invention, regarding a compressive restoration ratio (the compressive restoration ratio of a pedestal portion) R (%) when a pressure is released after the gasket is held for 1 to 672 hours in a state of being pressurized and compressed, it is particularly preferable that the compressive restoration ratio R be higher than that of a comparative gasket M corresponding to Patent Document 1 by 0.5 point or higher, and be higher than that of a comparative gasket N corresponding to Patent Document 2 by 1.0 point or higher.

### EFFECT OF THE INVENTION

The gasket made of the PFA obtained by the manufacturing method of Patent Document 1 is significantly improved in compressive restoration characteristics compared to a “gasket from an injection-molded product made of the PFA” which has been widely used hitherto. Therefore, the PFA gasket according to the manufacturing method of Patent Document 1 has gained public favor in the market.

However, as lithium secondary batteries have been rapidly spread, the development of a high-performance gasket having excellent compressive restoration characteristics is desired by the market. That is, a gasket of a lithium secondary battery for in-vehicle uses and industrial uses requires reliability such that the gasket can withstand use for a long period of time such as 10 years or longer.

However, the gasket of the invention reliably exceeds the high-level compressive restoration characteristics achieved by the invention of Patent Document 1 and the invention of Patent Document 2, and thus it can be said that the gasket of the invention reaches an untrodden level.

### BRIEF DESCRIPTION OF DRAWINGS

FIG. 1 is an explanatory view of gaskets G and M produced in Example 1 and Comparative Example 1, in which FIG. 1(A) is a plan view and FIG. 1(B) is a longitudinal sectional view;

FIG. 2 is an explanatory view of a gasket N produced in Comparative Example 2, in which FIG. 2(A) is a plan view and FIG. 2(B) is a longitudinal sectional view;

FIG. 3 is a longitudinal sectional view of a cut-out piece (p) which is cut from the gaskets G, M, and N respectively produced in Example 1, Comparative Example 1, and Comparative Example 2, for measurement of compressive restoration characteristics;

FIG. 4 is a schematic explanatory view illustrating a pressure jig (J) used for compressing the gaskets when compressive restoration characteristics are measured by using the cut-out piece (p) of FIG. 3, in which the lower side illustrates a body section (J1) (on which the cut-out piece (p) is placed) of the pressure jig (J), and the upper side illustrates a cover section (J2) of the pressure jig (J); and

FIG. 5 is a graph of measurement results of the compressive restoration characteristics of the gaskets G, M, and N produced in Example 1, Comparative Example 1, and Comparative Example 2, in which the logarithmic scale of the horizontal axis represents the compression time (hr) and the scale of the vertical axis represents the degree of restoration (that is, compressive restoration ratio (%)).

### MODE(S) FOR CARRYING OUT THE INVENTION

Hereinafter, the invention will be described in detail.

### (Material of Gasket and Properties of PFA)

The material of a gasket of the invention is a tetrafluoroethylene-perfluoroalkyl vinyl ether copolymer (PFA).

The representative properties of the PFA are as follows (measurement methods are in parentheses).

It can be seen that the PFA is extremely excellent as the gasket material.
Specific gravity: 2.12 to 2.17 (D792)
Melting point: about 302° C. to 310° C.
Melt flow rate (MFR): 1.5 g/10 min to 2.5 g/10 min
Hardness: D60 to D70 in shore hardness (D636)
Izod impact strength: not broken (D256)
Tensile strength: 19 MPa to 56 MPa (D638)
Elongation: 250% to 610% (D638)
Bending modulus of elasticity: 640 MPa to 700 MPa
Continuous use temperature: 260° C.
Coefficient of linear expansion: 12×10⁻⁵/° C. (D696)
Dielectric breakdown voltage: 20 KV/mm (D149)
Volume resistivity: >10¹⁸ Ω·cm (D257)
Flammability: V-0 (UL-94)
Limiting oxygen index: >95 VOL % (D2863)
Water absorption: lower than 0.03% (D570)
Chemical resistance: ⊙ for any of acids, alkalis, and solvents (D543)

### (Gasket of the Invention)

The gasket of the invention is a hot-press and cold-press molded product obtained by hot-pressing a skived sheet obtained by skiving a block-shaped molded body made of the PFA so as to be deformed into a gasket shape and thereafter performing cold-pressing on the resultant to fix a shape thereof.

### (Block-Shaped Molded Body)

Here, it is particularly preferable that the block-shaped molded body be a columnar or cylindrical molded body obtained by injecting a PFA raw material into a heated mold so as to be pressurized and cooling the material under pressure (although the mold can be heated after the PFA raw material is injected into the mold, in this case, productivity (manufacturing efficiency) deteriorates).

The reason why the columnar or cylindrical molded body is particularly preferable is that a skiving operation in the subsequent process is facilitated and the material can be formed into sheets in the skiving process without being wasted.

In addition, it is particularly preferable that the block-shaped molded body be obtained by molding the PFA raw material in a transfer molding method.

Transfer molding is a molding method in which, while a resin is melted in a cylinder, the molten resin liquid is injected into a metering pot, the resin liquid accumulated in the metering pot is pushed into the mold at once through an injection port to fill the mold, and the molded body is released after being cooled.

After the transfer molding, in order to relieve or remove the internal stress of the block-shaped molded body, heat treatment or annealing may be typically performed.

The molded body which is cooled and solidified and is released from the mold has the same specific gravity as the true specific gravity of the PFA or has a specific gravity similar to the true specific gravity thereof.

Molding methods other than the transfer molding method may be employed as long as the orientation of molecules of the block-shaped molded body is reduced in the molding methods.

The molded body obtained in this manner has the same specific gravity as the true specific gravity of the PFA or has a specific gravity similar to the true specific gravity thereof.

### (Production of Skived Sheet)

In a representative example in which the molded body is columnar or cylindrical, skiving of the block-shaped molded body is performed by allowing a blade to abut the surface of the column or the cylinder while rotating the column or the cylinder. That is, the molded body is sliced (that is, “skived”) by peeling away a film from the outer peripheral surface of the column or the cylinder.

Accordingly, a skived sheet having a uniform thickness can be continuously produced.

The thickness of the skived sheet at this time can be set in various manners, and is, for example, about 0.25 mm to 1 mm when a case of obtaining a very small gasket for a lithium-ion secondary battery is exemplified.

### (Production of Gasket)

By hot-pressing the skived sheet prepared as described above to be deformed into a gasket shape and cold-pressing the resultant, a target gasket which is a hot-press and cold-press molded product of which the shape is fixed can be obtained.

More specifically, the skived sheet obtained as described above is punched or cut into predetermined dimensions thereby forming chip-like small pieces (called a blank material), and the blank material is inserted into the mold. After the blank material is heated and deformed under pressure, the blank material is cooled under pressure.

It is particularly preferable that the hot-press and cold-press molded product be a product which is hot-pressed into the gasket shape under a temperature condition lower than the melting point of the PFA that is used by 0° C. to 80° C. and is thereafter cooled under pressure.

A preferable range of the temperature conditions is a temperature range lower than the melting point by 10° C. to 70° C., an even more preferable range thereof is a temperature range lower than the melting point by 20° C. to 60° C., and a particularly preferable range thereof is a temperature range lower than the melting point by 30° C. to 50° C.

Subsequently, the pressure is released, and a product gasket having a punched disk shape or another predetermined shape is released. When a plurality of blank materials are employed, at an arbitrary time point after the molding, individual gaskets are punched or cut to produce product gaskets G.

### (Compressive Restoration Ratio of Gasket)

First, the definition of a compressive restoration ratio is described. Under constant temperature/humidity conditions of a temperature of 23° C. and a humidity of 65%, a sample gasket with a pedestal portion having a thickness d1 is held in a state of being pressurized and compressed to achieve a thickness of 60% of the thickness d1 for t hours (hr), a thickness when the pressure is released after the holding is expressed as d2, and a compressive restoration ratio expressed by “100×d2/d1” is expressed as R (%).

(1) A gasket with a pedestal portion having a thickness d1, which is obtained by heating an extrusion-molded sheet made of the same grade of PFA under pressure so as to be deformed into a gasket shape and cooling the resultant under pressure, is referred to as a comparative gasket M.

The comparative gasket M corresponds to the representative gasket (packing) in Patent Document 1 and corresponds to a gasket of Comparative Example 1, which will be described later.

(2) A gasket with a pedestal portion having a thickness d1, which is obtained by deforming a skived sheet, which is obtained from a columnar body made by performing direct pressure molding on the same grade of PFA, into a gasket shape at room temperature under pressure, is referred to as a comparative gasket N.

The comparative gasket N corresponds to the representative gasket (packing) in Patent Document 2 and corresponds to a gasket of Comparative Example 2, which will be described later.

In addition, the gasket of the invention according to claim 1, 2, or 3 is referred to as a gasket G.

The gasket G corresponds to a gasket of Example 1, which will be described later.

It is particularly preferable that the gasket G of the invention show a compressive restoration ratio as follows.

That is, over the entire range of t=1 to 672 (hr) described above, the compressive restoration ratio R of the gasket G of the invention is
higher than the compressive restoration ratio R of the comparative gasket M described above in (1) by 0.5 point or higher, preferably 0.8 point or higher, and even more preferably 1.0 point or higher, and
higher than the compressive restoration ratio R of the comparative gasket N described above in (2) by 1.0 point or higher, preferably 2.0 point or higher, and even more preferably 3.0 point or higher.

### EXAMPLES

Next, the invention will be further described with reference to Examples.

### Example 1

### [Production of Disk-Shaped Molded Body and Production of Skived Sheet]

A molded body was obtained by a transfer molding method using a pellet-like PFA raw material having a melting point of 310° C. and an MFR of 2.0, annealing was performed at a temperature of 300° C. thereon, and a number of straightly cylindrical (disk-shaped) molded bodies having an outer diameter of 300 mm, an inner diameter of 50 mm, and a height of 15 mm were obtained.

Next, by skiving the disk-shaped molded body by allowing a blade to abut the outer peripheral surface side thereof while rotating the molded body around the center axis thereof, a skived sheet having a thickness of 0.98 mm was produced.

### [Production of Product Gasket]

The skived sheet obtained as described above was punched into predetermined dimensions, and a punched hole formed at the center of the product gasket was formed simultaneously.

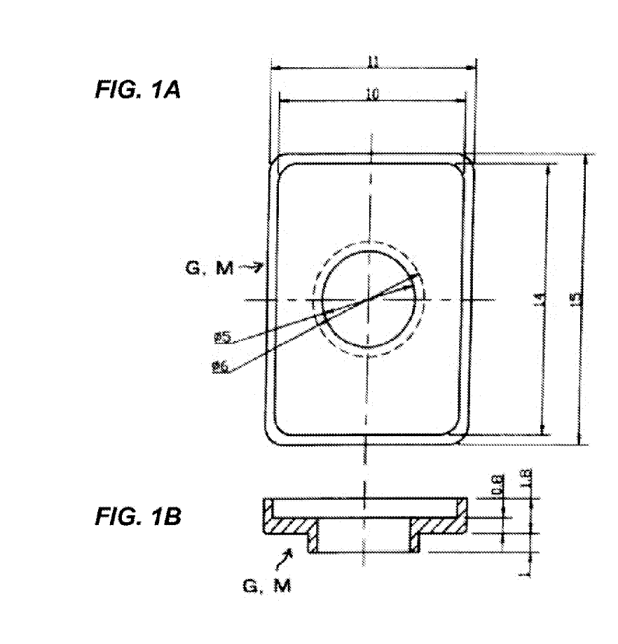

In addition, the obtained punched product was supplied into a mold, was heated to a temperature of 270° C., was pressurized under a pressure condition of 100 kg/cm², and was thereafter cooled while the pressurization conditions were maintained, thereby producing a number of product gaskets G which were rectangular in a plan view as illustrated in a plan view of FIG. 1(A) and a longitudinal sectional view of FIG. 1(B).

The gasket G had a shape in which, the peripheral wall of the rectangular pedestal portion with rounded corners was erected in a plan view, had a shallow funnel shape in a side view, and was provided with a through-hole at the center portion of the pedestal portion.

The dimensions of the gasket G are added to FIGS. 1(A) and 1(B), and in the plan view of FIG. 1(A), the outer width of the pedestal portion is 11.0 mm×15.0 mm, and the width of the peripheral wall is 0.5 mm. In the side view of FIG. 1(B), the height of the peripheral wall erected from the edge portion of the upper surface of the pedestal portion is 1.0 mm, the thickness of the pedestal portion is 0.8 mm, the height of the funnel-shaped portion of the pedestal portion is 1.8 mm, and thus the height of the funnel-shaped portion of a portion that protruded downward from the bottom surface of the pedestal portion is 1.0 mm. The inner diameter (that is, the diameter of a solid line circle of FIG. 1(A)) of the funnel-shaped portion is 5.0 mm, and the outer diameter (that is, the diameter of a broken line circle of FIG. 1(A)) of the funnel-shaped portion is 6.0 mm.

### Comparative Example 1

According to the method of Patent Document 1 described in “Background Art”, a punched product obtained by “punching a PFA sheet produced by extrusion molding” was supplied into a mold, was heated to a temperature of 270° C., was pressurized under a pressure condition of 100 kg/cm², and was thereafter cooled while the pressurization conditions were maintained, thereby producing a product gasket M as illustrated in the plan view of FIG. 1(A) and the longitudinal sectional view of FIG. 1(B).

### Comparative Example 2

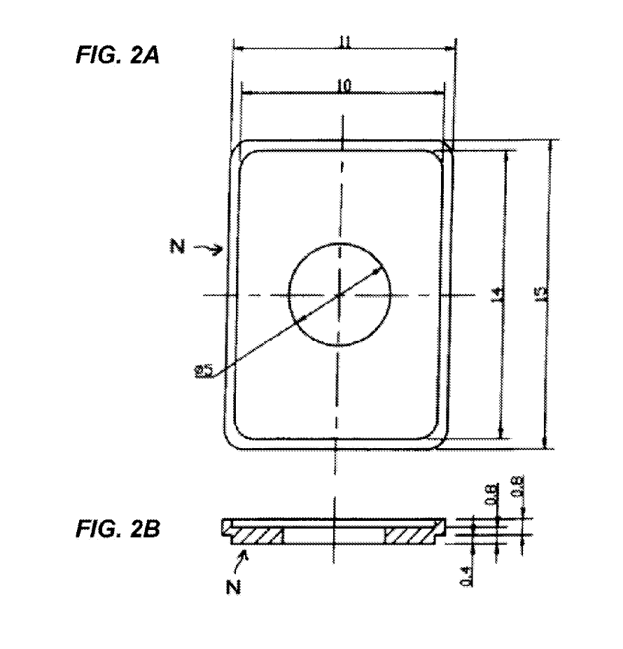

According to the method of Patent Document 2 described in “Background Art”, a skived sheet was produced under the same conditions as those of Example 1. However, in this case, unlike Example 1 described above, by performing “cold-press molding” on the skived sheet at “room temperature (20° C. to 25° C.)”, a product gasket N as illustrated in a plan view of FIG. 2(A) and a longitudinal sectional view of FIG. 2(B) was produced.

The dimensions of each portion in the plan view of FIG. 2(a) are the same as those of the case of FIG. 1(A) described above (however, a broken line circle of FIG. 1(A) is not present).

Regarding the dimensions of each portion in the side view of FIG. 2(B), the height of the peripheral wall erected from the upper surface of the pedestal portion is 0.4 mm, and the thickness of the pedestal portion is 0.8 mm. However, the four sides of the lower portion of the peripheral wall of the pedestal portion have cut-out shapes as in FIG. 2(B), and the thickness of the pedestal portion in the site is 0.4 mm.

While the gaskets of FIG. 1 according to Example 1 and Comparative Example 1 described above have the “funnel shape” in the side view, the shape of the gasket according to Comparative Example 2 is an “almost flat shape” in the side view as in FIG. 2(B) because, when a funnel shape is formed by cold-press molding, the occurrence of strain in the obtained molded body cannot be avoided, and the reliability of the molded body as a gasket product is damaged.

### [Test of Compressive Restoration Characteristics and Test]

### (Gasket Provided for Test)

In a test of compressive restoration characteristics, the gaskets produced in Example 1 (FIG. 1), Comparative Example 1 (FIG. 1), and Comparative Example 2 (FIG. 2) described above were used.

### (Preparation of Cut-out Piece (p) for Measurement and Preparation of Pressure Jig (J))

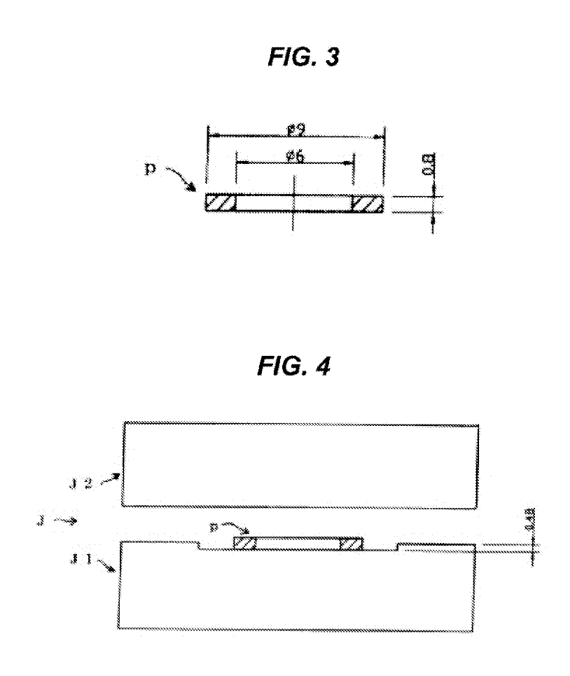

FIG. 3 is a longitudinal sectional view of a cut-out piece (p) which is cut from the pedestal portion of the gasket G produced in Example 1, the gasket M produced in Comparative Example 1, and the gasket N produced in Comparative Example 2, for measurement of compressive restoration characteristics.

The cut-out piece (p) has a flat ring shape and has an outer diameter of 9.0 mm, an inner diameter of 6.0 mm, and a thickness of 0.8 mm.

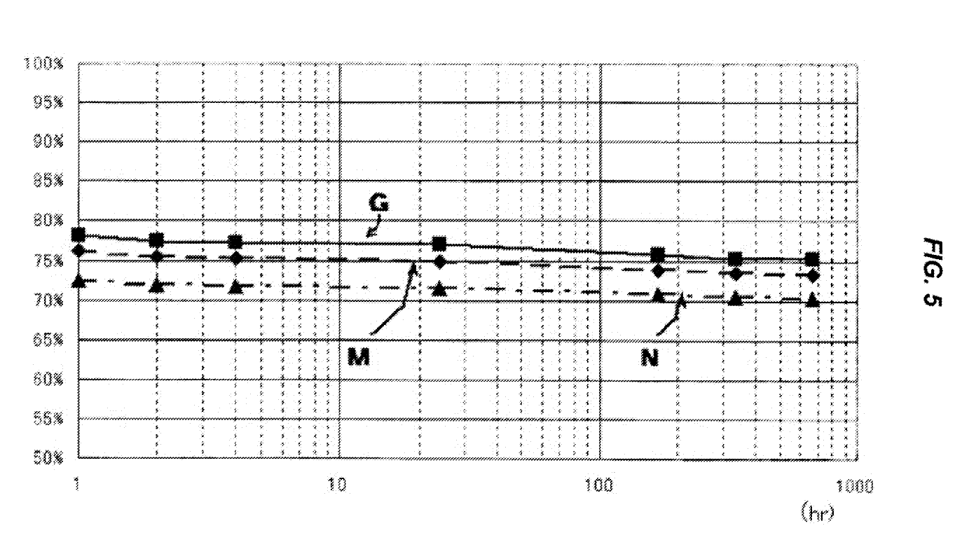

FIG. 4 is a schematic explanatory view illustrating a pressure jig (J) used for the measurement of compressive restoration characteristics. A lower member of FIG. 4 is a body section (J1) of the pressure jig (J), and an upper member of FIG. 4 is a cover section (J2) of the pressure jig (J).

### (Operation of Measurement Test)

By using the cut-out piece (p) cut as in FIG. 3 from each of the gaskets G, M, and N of Example 1, Comparative Example 1, and Comparative Example 2 prepared as described above as a test piece, a test for measuring compressive restoration characteristics was performed.

This test was conducted by cutting the test piece illustrated in FIG. 3 from each of the pedestal portions of the gaskets G, M, and N, placing the test piece on the body section (J1) of the pressure jig (J) of FIG. 4 provided with a slit having a depth of 0.48 mm, and pressing the test piece by tightening the cover section (J2) with bolts for a predetermined time so as to be in a compressed state.

Regarding the pressing at this time, the pedestal portions of the product gaskets G, M, and N were pressed for a predetermined time (1 hour to 672 hours) until the thickness (0.8 mm) of the portion thereof reaches 60% (0.48 mm) of the original thickness, and thereafter measurement was performed after 30 minutes from the pressure release.

The test was performed by repeating an operation of compressing a large number of each of the gaskets G, M, and N of Example 1, Comparative Example 1, and Comparative Example 2, extracting the test piece from the pressure jig (J) every predetermined time (1 hour, 2 hours, 4 hours, 24 hours (1 day), 168 hours (7 days), 336 hours (14 days), and 672 hours (28 days)), measuring the thickness of the pedestal portion of the test piece, and re-compressing the test piece with the pressure jig (J).

### (Measurement Results)

A graph of the measurement results of compressive restoration characteristics is shown in FIG. 5.

In FIG. 5, the horizontal axis represents the compression time (hr) and is set as logarithmic scale. The vertical axis represents the degree of restoration and represents the degree of restoration when it is assumed that the thickness before the test (the original thickness) is 100% and the test piece is maintained in a state where the test piece is compressed by 40% to have a thickness of 60% of the original thickness. In addition, each point plotted in FIG. 5 represents the average value of five measurement values.

In FIG. 5, three lines including “an upper broken line 1 connecting the plotted black squares”, “an intermediate broken line 2 connecting the plotted black diamonds”, and “a lower broken line 3 connecting the plotted black triangles” are drawn.

The upper broken line 1 (connecting the black squares) corresponds to the invention and represents the compressive restoration characteristics of the gasket shape obtained by “hot-press molding the skived sheet”.

The intermediate broken line 2 (connecting the black diamonds) corresponds to Patent Document 1 and represents the compressive restoration characteristics of the gasket shape obtained by “hot-press molding the molten and extrusion-molded sheet”.

The lower broken line 3 (connecting the black triangles) corresponds to Patent Document 2 and represents the compressive restoration characteristics of the gasket shape obtained by “cold-press molding the skived sheet”.

From FIG. 5, it can be seen that, regarding the compressive restoration characteristics, the gaskets are in order of preference of

1: “the hot-press molded product from the skived sheet of the invention (broken line 1/black squares)”,

2: “the hot-press molded product from the molten and extrusion-molded sheet corresponding to Patent Document 1 (broken line 2/black diamonds)”, and

3: “the cold-press molded product from the skived sheet corresponding to Patent Document 2 (broken line 3/black triangles)”.

### DISCUSSION

### Regarding Patent Document 2

Both of the gasket G of the invention (broken line 1/black squares) and the gasket N of Patent Document 2 (broken line 3/black triangles) are derived from the skived sheet, and the processes of “compression molding of the PFA raw material”, “annealing of the compression molded product”, and “production of the skived sheet” are common to both.

However, in Patent Document 2, the gasket N is produced by performing cold-press molding on the skived sheet at about room temperature. Therefore, it is assumed that the internal stress (force of restoration) remaining in the pedestal portion is different and thus the restoration force rarely remains compared to the gasket G of the invention.

On the other hand, in Example 1 according to the invention, the gasket G is produced by hot-pressing the skived sheet at a temperature of 270° C. which is lower than the melting point (310° C.) of the PFA by 40° C. and cooling the resultant under pressure to fix the shape thereof. Therefore, it is thought that a corresponding internal pressure remains in the pedestal portion, and thus sufficient restoration force is exhibited.

### Regarding Patent Document 1

The hot-press molded product (broken line 2/black diamonds) of the molten and extrusion-molded sheet corresponding to Patent Document 1 is started from the “molten and extrusion-molded sheet”. Therefore, it is thought that the orientation of molecules in the gasket M is too significantly aligned with the horizontal direction and a force of restoration against the pressure applied to the pedestal portion of the gasket M in the vertical direction cannot be maintained in the degree of the invention.

On the other hand, in Example 1 according to the invention, as described above, the gasket G is produced by hot-pressing the skived sheet at a temperature of 270° C. which is lower than the melting point (310° C.) of the PFA by 40° C. and cooling the resultant under pressure to fix the shape thereof, it is thought that a corresponding internal pressure remains in the pedestal portion, and thus sufficient restoration force is exhibited.

Furthermore, in Example 1, the block-shaped molded body is obtained by the transfer molding method (while a resin is melted in a cylinder, the molten resin liquid is injected into a metering pot, the resin liquid accumulated in the metering pot is pushed into the mold at once through an injection port to fill the mold, and the molded body is released after being cooled), and the gasket G is obtained as described above by using the skived sheet obtained by skiving the molded body. Therefore, it is thought that the orientation direction of molecules in the gasket is also present in the vertical direction as well as the horizontal direction, and thus also contributes to the enhancement of the compressive restoration characteristics.

### INDUSTRIAL APPLICABILITY

The gasket of the invention has preferable compressive restoration characteristics as described above and is thus extremely useful as a gasket for a secondary battery, and particularly a lithium secondary battery.

### EXPLANATIONS OF LETTERS OR NUMERALS

G gasket of the invention (Example 1)

M gasket of Patent Document 1 (Comparative Example 1)

N gasket of Patent Document 2 (Comparative Example 2)

(p) cut-out piece

(J) pressure jig

(J1) body section (of pressure jig)

(J2) cover section (of pressure jig)

1. A gasket for a secondary battery, which is a gasket used as an insulation seal of a secondary battery,
wherein a material of the gasket is made of a tetrafluoroethylene-perfluoroalkyl vinyl ether copolymer (PFA), and
the gasket is a hot-press and cold-press molded product obtained by hot-pressing a skived sheet obtained by skiving a block-shaped molded body made of the PFA so as to be deformed into a gasket shape and thereafter performing cold-pressing on the resultant to fix a shape thereof.

2. The gasket for a secondary battery according to claim 1,
wherein the block-shaped molded body is a columnar or cylindrical molded body obtained by injecting a PFA raw material into a heated mold so as to be pressurized and cooling the material under pressure, and
the hot-press and cold-press molded product is a product which is hot-pressed into the gasket shape under a temperature condition lower than a melting point of the PFA that is used by 0° C. to 80° C. and is thereafter cooled under pressure.

3. The gasket for a secondary battery according to claim 1,
wherein the block-shaped molded body is obtained by molding the PFA raw material in a transfer molding method.

4. (canceled)

5. The gasket for a secondary battery according to claim 2,
wherein the block-shaped molded body is obtained by molding the PFA raw material in a transfer molding method.

6. The gasket for a secondary battery according to claim 1,
wherein, when a thickness when a pressure is released after holding a sample gasket with a pedestal portion having a thickness d1 for t hours under constant temperature/humidity conditions of a temperature of 23° C. and a humidity of 65% in a state where the sample gasket is in a state of being pressurized and compressed to achieve a thickness of 60% of the thickness d1 is expressed as d2, a compressive restoration ratio expressed by “100×d2/d1” is expressed as R (%),
(1) a gasket with a pedestal portion having the thickness d1, which is obtained by heating an extrusion-molded sheet made of the same grade of PFA under pressure so as to be deformed into a gasket shape and cooling the resultant under pressure, is referred to as a comparative gasket M, and
(2) a gasket with a pedestal portion having the thickness d1, which is obtained by deforming a skived sheet, which is obtained from a columnar body made by performing direct pressure molding on the same grade of PFA, into a gasket shape at room temperature under pressure, is referred to as a comparative gasket N,
over the entire range of t=1 to 672, the compressive restoration ratio R of the gasket G according to claim 1, 2, or 3 is higher than the compressive restoration ratio R of the comparative gasket M by 0.5 point or higher, and is higher than the compressive restoration ratio R of the comparative gasket N by 1.0 point or higher.

7. The gasket for a secondary battery according to claim 2,
wherein, when a thickness when a pressure is released after holding a sample gasket with a pedestal portion having a thickness d1 for t hours under constant temperature/humidity conditions of a temperature of 23° C. and a humidity of 65% in a state where the sample gasket is in a state of being pressurized and compressed to achieve a thickness of 60% of the thickness d1 is expressed as d2, a compressive restoration ratio expressed by “100×d2/d1” is expressed as R (%),
(1) a gasket with a pedestal portion having the thickness d1, which is obtained by heating an extrusion-molded sheet made of the same grade of PFA under pressure so as to be deformed into a gasket shape and cooling the resultant under pressure, is referred to as a comparative gasket M, and
(2) a gasket with a pedestal portion having the thickness d1, which is obtained by deforming a skived sheet, which is obtained from a columnar body made by performing direct pressure molding on the same grade of PFA, into a gasket shape at room temperature under pressure, is referred to as a comparative gasket N,
over the entire range of t=1 to 672, the compressive restoration ratio R of the gasket G according to claim 1, 2, or 3 is higher than the compressive restoration ratio R of the comparative gasket M by 0.5 point or higher, and is higher than the compressive restoration ratio R of the comparative gasket N by 1.0 point or higher.

8. The gasket for a secondary battery according to claim 3,
wherein, when a thickness when a pressure is released after holding a sample gasket with a pedestal portion having a thickness d1 for t hours under constant temperature/humidity conditions of a temperature of 23° C. and a humidity of 65% in a state where the sample gasket is in a state of being pressurized and compressed to achieve a thickness of 60% of the thickness d1 is expressed as d2, a compressive restoration ratio expressed by “100×d2/d1” is expressed as R (%),
(1) a gasket with a pedestal portion having the thickness d1, which is obtained by heating an extrusion-molded sheet made of the same grade of PFA under pressure so as to be deformed into a gasket shape and cooling the resultant under pressure, is referred to as a comparative gasket M, and
(2) a gasket with a pedestal portion having the thickness d1, which is obtained by deforming a skived sheet, which is obtained from a columnar body made by performing direct pressure molding on the same grade of PFA, into a gasket shape at room temperature under pressure, is referred to as a comparative gasket N,
over the entire range of t=1 to 672, the compressive restoration ratio R of the gasket G according to claim 1, 2, or 3 is higher than the compressive restoration ratio R of the comparative gasket M by 0.5 point or higher, and is higher than the compressive restoration ratio R of the comparative gasket N by 1.0 point or higher.

9. The gasket for a secondary battery according to claim 4,
wherein, when a thickness when a pressure is released after holding a sample gasket with a pedestal portion having a thickness d1 for t hours under constant temperature/humidity conditions of a temperature of 23° C. and a humidity of 65% in a state where the sample gasket is in a state of being pressurized and compressed to achieve a thickness of 60% of the thickness d1 is expressed as d2, a compressive restoration ratio expressed by “100×d2/d1” is expressed as R (%),
(1) a gasket with a pedestal portion having the thickness d1, which is obtained by heating an extrusion-molded sheet made of the same grade of PFA under pressure so as to be deformed into a gasket shape and cooling the resultant under pressure, is referred to as a comparative gasket M, and
(2) a gasket with a pedestal portion having the thickness d1, which is obtained by deforming a skived sheet, which is obtained from a columnar body made by performing direct pressure molding on the same grade of PFA, into a gasket shape at room temperature under pressure, is referred to as a comparative gasket N,
over the entire range of t=1 to 672, the compressive restoration ratio R of the gasket G according to claim 1, 2, or 3 is higher than the compressive restoration ratio R of the comparative gasket M by 0.5 point or higher, and is higher than the compressive restoration ratio R of the comparative gasket N by 1.0 point or higher.
